(19) United States
(12) Patent Application Publication
(10) Pub. No.: US 2018/0288850 A1
(43) Pub. Date: Oct. 4, 2018

(54) TRAJECTORY TRACKING USING LOW COST OCCUPANCY SENSOR

(71) Applicant: PHILIPS LIGHTING HOLDING B.V., EINDHOVEN (NL)

(72) Inventors: ROHIT KUMAR, HACKENSACK, NJ (US); MAULIN DAHYABHAI PATEL, TUCKAHOE, NY (US)

(21) Appl. No.: 15/770,108

(22) PCT Filed: Oct. 14, 2016
(86) PCT No.: PCT/EP2016/074781

§ 371 Date: Apr. 20, 2018

Related U.S. Application Data
(60) Provisional application No. 62/244,952, filed on Oct. 22, 2015.

(51) Int. Cl. H05B 37/02; G01J 5/10; G01J 5/00; G01J 5/02

(52) U.S. Cl. CPC H05B 37/0227; G01J 5/10; G01J 2005/106; G01J 5/027; G01J 5/0022

(57) ABSTRACT

A system and method for tracking a trajectory of a target within a space. The system and method determining a current time instant, detecting a movement of at least one target in a space at the current time instant to generate a current sensor measurement, and determining a current state of the at least one target based on the current sensor measurement.

### BACKGROUND

Many lighting systems include occupancy sensors such as passive infrared (PIR) sensors to detect occupancy in a space and permit energy savings. The PIR sensor detects motion when there is a change in the infrared radiation and the gradient is above a certain threshold. The lighting system may switch off or dim the lights when it detects that a space is vacated (i.e., no motion is detected). These PIR sensors, however, often suffer from the problem of false negatives and false positives. For example, if there is a person reading a book in a room, he may be sitting and not moving much. The gradient change in this case is small and will cause the occupancy sensor to infer that the space is vacated (e.g., false negative). In turn, this will cause the lights to be switched off causing discomfort to the user. Alternatively, the occupancy sensor may read motion due to, for example, fans, vents and moving of blinds (e.g., false positives) and activates the lighting system causing energy waste. Using alternative means for sensing occupancy (e.g., video cameras, thermopile sensors) may be costly and/or raise privacy concerns.

### SUMMARY

A method for tracking a trajectory of a target within a space. The method including determining a current time instant, detecting a movement of at least one target in a space at the current time instant to generate a current sensor measurement, and determining a current state of the at least one target based on the current sensor measurement.

A system for tracking a trajectory of a target within a space. The system including a processor determining a current time instant and a plurality of sensors detecting a movement of at least one target in a space at the current time instant to generate a current sensor measurement, wherein the processor determines a current state of the at least one target based on the current sensor measurement.

A non-transitory computer-readable storage medium including a set of instructions executable by a processor. The set of instructions, when executed by the processor, causing the processor to perform operations, comprising determining a current time instant, detecting a movement of at least one target in a space at the current time instant to generate a current sensor measurement, and determining a current state of the at least one target based on the current sensor measurement.

### BRIEF DESCRIPTION

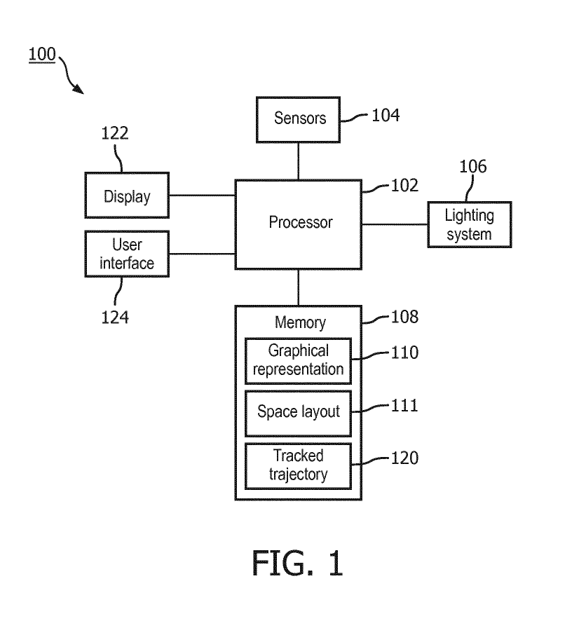

FIG. 1 shows a schematic drawing of a system for tracking the trajectory of a user to determine a light setting according to an exemplary embodiment.

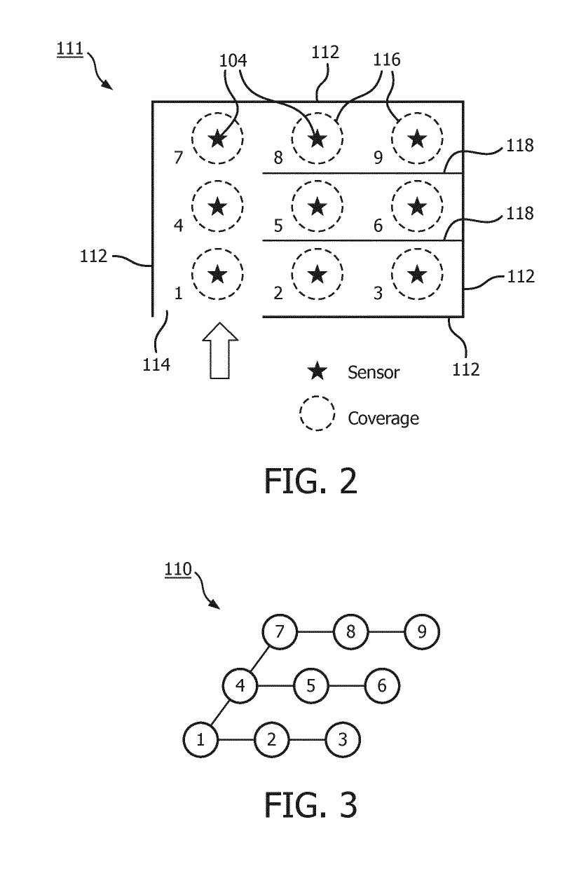

FIG. 2 shows a schematic drawing of a space layout according to an exemplary embodiment.

FIG. 3 shows a graphical representation of the space layout of FIG. 2.

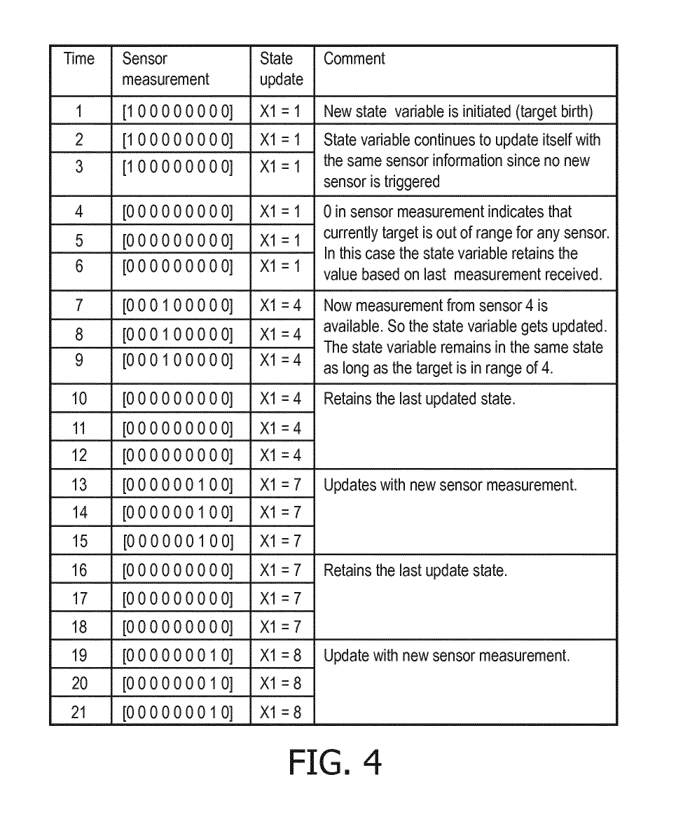

FIG. 4 shows a table showing an exemplary output for an algorithm tracking the trajectory of a user according to an exemplary embodiment.

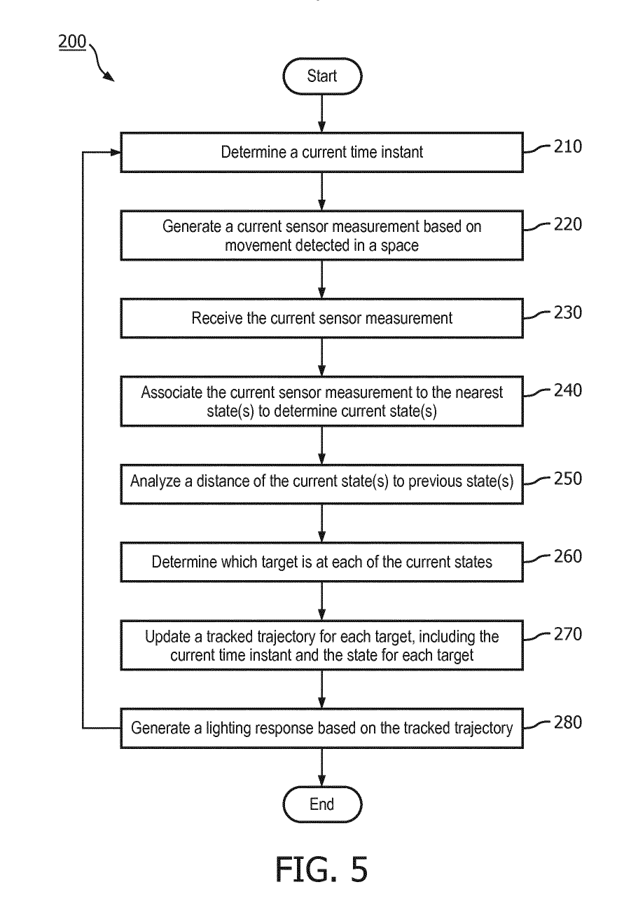

FIG. 5 shows a flow chart of a method for tracking the trajectory of a user according to an exemplary embodiment.

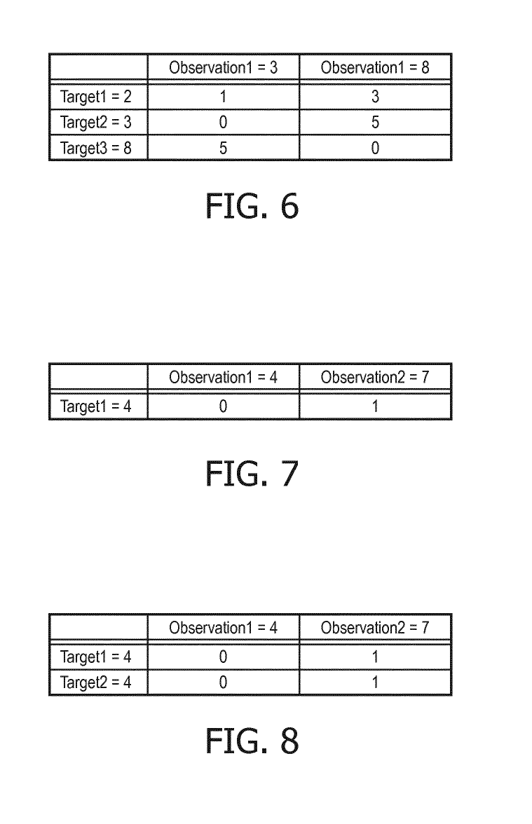

FIG. 6 shows a table of an example in which a number of targets exceeds a number of detected states.

FIG. 7 shows a table of an example in which a number of targets is less than a number of detected states.

FIG. 8 shows a table of an example in which a number of targets is equal to a number of detected states.

### DETAILED DESCRIPTION

The exemplary embodiments may be further understood with reference to the following description and the appended drawings wherein like elements are referred to with the same reference numerals. The exemplary embodiments relate to a system and method for tracking a trajectory of a target within a defined space. In particular, the exemplary embodiments describe tracking the trajectory of the target using a location of occupancy sensors within the space. Time stamped measurements from occupancy sensors are triggered by the target's motion to track the trajectory of the person and determine the motion and location of the target. A lighting response (e.g., lights on, lights off, lights dimmed, etc.) may be generated based on the determined occupancy of the space.

As shown in FIG. 1, a system 100 according to an exemplary embodiment of the present disclosure tracks a trajectory of one or more active targets (e.g., user or occupant) within a space to determine whether the space is still occupied and to generate a lighting response. In particular, the system mitigates the issue of false negatives (e.g., when a person occupies the space but may be very still so as not to trigger a motion sensor) and false positives (e.g., when a person does not occupy the space but movements resulting from heating and/or air vents may trigger a motion sensor) by tracking the trajectory of the active target(s) to accurately determine whether the space is occupied and to generate the appropriate lighting response. The system 100 comprises a processor 102, a plurality of sensors 104, a lighting system 106 and a memory 108. The plurality of sensors 104 (e.g., PIR sensors) are positioned at known locations within a space (e.g., office, mall). In a further embodiment, graphical representation 110 of a space layout 111 including a position and/or location 116 (FIG. 2) of the occupancy sensors 104 within the space may be stored in the memory 108. The graphical representation 110 may include legitimate paths of travel from one point to another point within the space.

In one embodiment, the processor 102 may generate the graphical representation 110 from a space layout 111 stored in the memory 108. For example, as shown in FIG. 2, the space layout 111 may show four walls 112 and an opening 114 or doorway defining the space. The plurality of occupancy sensors 104 are positioned at known locations 116 throughout the space and may be represented via numbered nodes. A size of each of the location nodes 116 may indicate a coverage area of each of the sensors 104. The space layout 111 may also show obstructions 118 such as, for example, work desks or storage units positioned within the space, which prevent random movements in the space. For example, a target cannot move directly from location 3 to location 6. A target entering the room, who wishes to travel to location 9 must pass through locations 1, 4, 7 and 8 triggering the sensors 104 at each of these corresponding locations. Thus, using the space layout 111, the processor 102 may generate the graphical representation 110, as shown in FIG. 3, which shows the locations 116 of the sensors 104 and possible paths of travel between locations 116. This graphical representation 110 may also be stored to the memory 108.

The sensors 104 are triggered when the target(s) move within the location 116 in which a corresponding sensor 104 is located. Thus, when a sensor 104 is triggered, the processor 102 receives a sensor measurement including a binary output (‘1’ to indicate motion and ‘0’ to indicate no motion) for each of the sensors 104 to indicate location(s) 116 within which motion was detected. For example, using the exemplary space layout 111 and graphical representation 110 described above and shown in FIGS. 2 and 3, if the sensors 104 detect a movement at location 1, the sensors 104 would output the sensor measurement [1 0 0 0 0 0 0 0 0]. If the sensors 104 detect a subsequent movement at location 4, the sensor measurement would be [0 0 0 1 0 0 0 0 0]. Each binary output is time stamped so that a trajectory of the user may be tracked.

FIG. 4 shows a table showing an exemplary series of outputs provided to the processor 102 to track a location of a target at a given time. A state (e.g., location of the user) is continuously updated to indicate the most current position of the user within the space. For example, at an initial time instant 1, the sensor measurement may be [1 0 0 0 0 0 0 0 0]. The processor 102 interprets this sensor measurement to mean that movement was detected in location 1. Thus, at time instant 1, the state of a target X1=1. At a time instant 2, the sensor measurement is also [1 0 0 0 0 0 0 0 0], indicating that the target X1 is still within the location 1. Thus, the state is maintained at X1=1. At time instant 4, however, the sensor measurement is shown as [0 0 0 0 0 0 0 0 0], indicating that the target X1 is out of range of any sensor within the space shown in FIG. 2. Assuming that the target X1 hasn't triggered an exit sensor (e.g., a sensor exterior of the space layout shown in FIG. 2 to indicate that the target X1 has vacated the space), the state variable retains the same state value of the last received measurement. In a traditional lighting system, if a sensor has not detected motion for a predetermined period of time, the system will turn off the light, resulting in a false negative. However, since the system 100 tracks the trajectory of the active target and the active targhet has not been tracked as leaving the space, the lights will not be turned off.

At time instant 7, the sensor measurement is [0 0 0 1 0 0 0 0 0], indicating that motion has been detected at location 4. Thus the state for target X1 is updated to show X1=4. For each time instant, the state is continuously updated, as described above, to determine a trajectory 120 of the target, which may be stored to the memory 108 and continuously updated to track the motion of the target through the space. Although the example in FIG. 4 shows a single target within a single defined space, it will be understood by those of skill in the art that multiple targets may be detected within the space and/or a series of spaces connected to or related to one another. For example, the system 100 may track the trajectory of target(s) through multiple offices (spaces) of an office building.

As long as the user is determined to occupy the space, the processor 102 may indicate to the lighting system 106 that the lights within the space should remain on. If the user is determined to have vacated the space, the processor 102 may indicate to the lighting system 106 that the lights within the space should be dimmed or turned off. Thus, the lighting response may be based on the tracked trajectory of each target.

The system 100 may further comprise a display 122 for displaying the tracked trajectory of the target(s) through the space and/or to show a status of a lighting system of the space. Further, the display 122 may display the trajectory of the target(s) through multiple spaces and the lighting status for multiple spaces. For example, the trajectory of targets through multiple office of an office building and/or the lighting status of an entire office building may be shown on the display 120. The system 100 may also further comprise a user interface 124 via which a user such as, for example, a building manager, may input alternate settings to control the lighting systems for the entire building. The user may, for example, provide input to override a lighting response generated by the processor 102. Although the exemplary embodiments show and describe an office space within an office building, it will be understood by those of skill in the art that the system and method of the present disclosure may be utilized in any of a variety of space settings such as, for example, a shopping mall.

FIG. 5 shows an exemplary method 200 for tracking a trajectory of a user within a space to control a lighting system using the system 100, described above. It should be noted that exemplary references to locations refer to the locations 116 depicted in the graphical representation 110 shown in FIG. 3. The method 200 includes determining a current time instant, in a step 210. Given n active targets (i.e., number of occupants in a space), with state variable x1(k−1), . . . xn(k−1), ‘k’ indicates the current time instant. For example, where the user(s) have just entered the space, the current time instant may be k1. Where prior sensor measurements have been received and analyzed, as will be described in further detail below, the current time instant may be kp, where ‘p−1’ is the number of prior sensor measurements that have been taken. It will be understood by those of skill in the art that the number if active targets at any given time is indicative of the number of occupants in the room at that time. In a step 220, the sensors 104 generate a current sensor measurement based on movement detected within the space. This sensor measurement may be received by the processor 102, in a step 230. As described above, the sensor measurement may be a binary output for each location at which a sensor 104 is located. For example, the processor 102 may receive the sensor measurement [0 0 0 0 1 0 0 1 0]. In a step 240, the processor 102 associates the current sensor measurement with the nearest state. For example, the above binary output would be interpreted as having detected motion at locations 5 and 8. Thus, current states of the targets would be determined to be 5 for a first one of the targets and 8 for a second one of the targets.

In a step 250, the processor 102 analyzes a distance of the current states to previous sensor measurements. Where the current states are for the initial time instant k1, this analysis is not necessary. Where a previous sensor measurement have been reported, however, the current states are compared to the states associated with the immediately prior sensor measurement. In an example in which the current states are determined to be 4 and 8 and the immediately prior states were determined to be X1=5 and X2=8, the current state of 4 is determined to be one node away from the immediately prior state 5 of X1 and four nodes away from the immediately prior state 8 of X2. The current state of 8 is determined to be 3 nodes away from 5 of X1 and 0 nodes away from 8 of X2.

In a step 260, the processor 102 determines which target is associated with each of the current states based on the distance of the current states to the immediately prior states. For example, since the current state of 4 is one node away from the immediately prior state 5, it is determined that the state 5 is the only possible neighbor. In other words, although it is possible for the target X1 to have moved from location 5 to location 4, it would be very unlikely for the target X1 to have moved from the location 5 to location 8 without having triggered detection via any of the other sensors 104 therebetween. Likewise, although it is possible for the target X2 to have stayed within the location 8, it is very unlikely that the target X2 could have moved from the location 8 to the location 4 without triggering any of the sensors 104 therebetween. Thus, the target X1=4 while the target X2=8. For embodiments in which the graphical representation, including space layout and legitimate paths of travel, are available, the step 260 may calculate the distance between the current and prior states using the graphical distance, as described above. It will be understood by those of skill in the art, however, that any of a variety of distance metrics may be used to calculate the distance such as, for example, Euclidean distance metrics.

Although there is only one candidate for each of the states in the above example, in some cases data association defining a set of rules may be necessary to determine the state of each target within a space. In a first case in which a number of targets exceeds a number of locations detecting movement in a given time instant, there are two possible options: (a) multiple targets have moved under one sensor (target merging), or (b) a target has left the space. FIG. 6 shows an example of target merging. In this example, at some instant, there are three users and only two measurements. The immediately prior states were determined to be: Target 1=2, Target 2=3 and Target 3=8. However, the sensors 104 only detected movement at two locations. Since the exit sensor is not triggered, the processor 102 concludes that the two targets are under the same sensor and cannot be distinguished due to the binary nature of the output. Thus, targets 1 and 2 are associated with the current state 3 (since the immediately prior states of targets 1 and 2 are within 1 node of the current state 3), while target 3 is associated with the current state 8 (since the immediately prior state of target 3 is within 1 node of the current state 8).

In a second case in which the number of targets is less than a number of locations detecting movement, one of two options are possible: (a) a new target has entered the space or (b) targets who were under a given sensor have not moved under independent sensors. For example, as shown in FIG. 7, during a prior sensor measurement, only one target was detected, in which the Target 1=4. The current sensor measurement, however, indicated two states—state 4 and state 7. Since a single target can only generate one measurement, it is clear that the two targets must exist. In this example, the processor 102 determines that two targets may have been within the range of a single sensor 104 at location 4 during the prior measurement. Thus, a new track trajectory for a second user is initiated.

In a third case in which the number of targets is equal to the number of locations detecting movement, it is implied that each target is generating its own independent measurement. In the example shown in FIG. 8, a prior measurement indicates that Target 1=4 and Target 2=4. Current states, however, are determined to be 4 and 7. Since an equal number of targets and detected states exist in this example, a rule of associating the state to the closest measurement and only one measurement can be assigned to a target. Thus, in this example, only one of the targets will be assigned the state 4 while the other of the targets will be determined to have moved to state 7.

Once the current state for each of the active targets has been determined in the step 260, the track trajectory 120 for each of the targets may be updated in the memory 108, in a step 270. This track trajectory 120, which includes the time instant and the state associated with each target, determines whether active targets are occupying the space to generate a lighting response, in a step 280. For example, where there is at least one active target in the space, the processor 102 may generate a lighting response instructing the lighting system 106 to turn on the lights (if a target is just entering the space) or to keep the lights on (if a target remains in the space). If all of the active targets are determined to have vacated the space, the processor 102 may generate a lighting response instructing the lighting system 106 to turn off or dim the lights in the space. The above-described steps of the method 200 are continuously repeated so that the system 100 may constantly provide optimal lighting for the space.

The above-described method 200 works under the assumption that the coverage area for each of the sensors 104 at the multiple locations are non-overlapping. In particular, the total usable space is seen by at least one sensor 104. In addition, one target can only be seen by one sensor 104 at a time. Therefore, if two sensors 104 are triggered, then there should be at least two targets in the space. In another embodiment, however, sensors may have overlapping coverage so that one target can trigger multiple sensors. When two sensors are triggered by a single target, the best estimate of a user position may be determined to be mid-way between the two sensors and/or equidistant from a center of all the sensors triggered by the target. In one embodiment, a distance between the new sensor measurements and the previous states may be determined to combine the multiple triggered sensor measurements into a single state for each target. Data assocation rules similar to the data association rules described above in regard to step 260 may also be utilized when more than one active target is in a space having overlapping coverage. For example, when the number of targets is less than a number of locations detecting movement (since one target may trigger multiple sensors), distances between prior and current states may be calculated to determine whether multiple triggered sensor locations may be attributed to one of the targets.

It is noted that the claims may include reference signs/numerals in accordance with PCT Rule 6.2(b). However, the present claims should not be considered to be limited to the exemplary embodiments corresponding to the reference signs/numerals.

Those skilled in the art will understand that the above-described exemplary embodiments may be implanted in any number of manners, including, as a separate software module, as a combination of hardware and software, etc.

1. A method for tracking a trajectory of a target within a space, comprising:
receiving a space layout of the space including locations of a plurality of sensors in the space;
determining an initial state of the plurality of sensors at an initial time instant by detecting movement of at least one target in the space at the initial time instant based on initial sensor measurements of each of the plurality of sensors;
determining a current state of the plurality of sensors at a current time instant based on current sensor measurements of each of the plurality of sensors; and
tracking a trajectory of the at least one target in the space based on the initial state or a previous state and the current state of the plurality of sensors and the space layout.

2. (canceled)

3. The method of claim 1, further comprising:
analyzing a distance of travel of the at least one target between the current state and a previous state based on the sensor measurements.

4. The method of claim 1, further comprising:
generating a graphical representation of the space based on the space layout and legitimate paths of travel of a target through the space.

5. The method of claim 4, wherein the space layout includes one of walls, an entry point into the space, and obstructions in the space.

6. (canceled)

7. The method of claim 1, further comprising:
generating a lighting response based on the current state of each of the plurality of sensors, wherein the light response mitigates false negatives and positives using the legitimate paths of travel through the space.

8. A system for tracking a trajectory of a target within a space, comprising:
a plurality of sensors to detect movement in the space;
a processor configured to receive a space layout of the space including locations of the plurality of sensors in the space, determine an initial state of the plurality of sensors at an initial time instant by detecting movement of at least one target in the space at the initial time instant based on initial sensor measurements of each of the plurality of sensors, determine a current state of the plurality of sensors at a current time instant based on current sensor measurements based on current states of each of the plurality of sensors, and track a trajectory of the at least one target in the space based on the initial state or a previous state and the current state of each of the plurality of sensors and the space layout.

9. (canceled)

10. The system of claim 8, wherein the processor analyzes a distance of travel of the at least one target between the current state and a previous state based on the sensor measurements.

11. The system of claim 8, wherein the processor generates a graphical representation of the space based on the space layout and legitimate paths of travel through the space, wherein the space layout includes one of walls, an entry point into the space, obstructions in the space and a location of a plurality of sensors in the space.

12. (canceled)

13. The system of claim 8, wherein the processor generates a lighting response based on the current state each of the plurality of sensors, the lighting response mitigating false negatives and positives using the legitimate paths of travel through the space.

14. The system of claim 8, wherein the lighting response includes one of turning off, turning on and dimming the lights in the space.

15. A non-transitory computer-readable storage medium including a set of instructions executable by a processor, the set of instructions, when executed by the processor, causing the processor to perform operations, comprising:
receiving a space layout of the space including locations of a plurality of sensors in the space;
an initial state of the plurality of sensors at an initial time instant by
detecting a movement of at least one target in the space at the initial time instant based on initial sensor measurements of each of the plurality of sensors;
determining a current state of the plurality of sensors at a current time instant based on the current sensor measurements of each of the plurality of sensors; and
tracking a trajectory of the at least one target in the space based on the initial state or a previous state and the current state of the plurality of sensors and the space layout.
